(19) United States
(12) Patent Application Publication
(10) Pub. No.: US 2006/0023690 A1
(43) Pub. Date: Feb. 2, 2006

(54) Method and apparatus for memory efficient carrier allocation and online reconfiguration in communication systems

(75) Inventors: Thyagarajan Umashankar, Munich (DE); Vladimir Oksman, Morganville, NJ (US)

Correspondence Address: Maginot, Moore & Beck, Bank One Tower, 111 Monument Circle, Suite 3000, Indianapolis, IN, 46204, US

(73) Assignee: Infineon Technologies AG, Munchen (DE)

(21) Appl. No.: 10/900,997

(22) Filed: Jul. 28, 2004

(51) Int. Cl. H04L 12/28

(52) U.S. Cl. 370/351

(57) ABSTRACT

According to a first aspect of the invention, a method for initializing a data transfer between a first communication device and a second communication device is provided, wherein said data transfer involves encoding and modulating data onto a plurality of carriers. A sequence of said carriers according to which the data is to be modulated onto said carriers which takes an encoding technique into account is calculated at said second communication device and transmitted to said first communication device, leading to a saving of memory. Furthermore, a method for adapting said data transfer is provided involving calculating changes to information concerning said data transfer in said second communication device and sending parameters indicative of the changes to said first communication device.

The present invention relates to a method and an apparatus for memory efficient carrier allocation and online reconfiguration in communication systems, in particular in communication systems using multi carrier modulation techniques like discrete multi tone modulation (DMT) and encoding like Trellis coding. Such modulation and encoding techniques are e.g. used in digital subscriber line (DSL) systems like ADSL (Asymmetric Digital Subscriber Line) and VDSL (Very High Bit Rate Digital Subscriber Line).

In multi carrier systems like DMT systems data bits of data to be sent are modulated onto a plurality of carriers using a modulation technique like quadrature amplitude modulation (QAM) for each carrier. The carriers are also referred to as tones. The number of bits that can be modulated onto a single carrier of said plurality of carriers is a function of the properties of the channel over which the signal is to be transmitted, in particular a function of a signal to noise ratio (SNR) and attenuation. During an initialization phase of a communication between a transmitter and a receiver, the receiver measures the noise conditions for each carrier, e.g. by analyzing a test sequence sent by the transmitter, and determines how many bits can be modulated onto each carrier. This process is commonly referred to as bit loading.

Furthermore, for each of the carriers a transmit power can be adjusted, which is referred to as gain scaling, wherein the overall transmit power of all the carriers used usually remains constant. Finally, a sequence according to which the carriers are loaded with bits is also determined by the receiver. Therefore, at the receiver, a so-called tone ordering table which contains said sequence, a bit table which contains information regarding how many bits are to be loaded onto each of the carriers and a gain table describing the gain or transmit power used for each carrier is generated at the receiver.

These tables are transmitted to the transmitter so that the tables are stored both at the transmitter and the receiver to be used for modulating and demodulating. These tables usually remain static for the duration of the communication session until the system is reinitialized.

In DSL systems, to ensure a lower bit error rate, encoding techniques, in particular Trellis coding, are used. However, the tone ordering table as described above is not suitable for Trellis coding since to create a so-called Trellis constellation at least two bits are needed, making it difficult to make use of those carriers onto which only one bit may be modulated and which are, as a rule, randomly distributed over the tone ordering table as described above. Therefore, a reordering is performed to create a reordered tone ordering table, wherein carriers onto which only one bit are modulated are grouped together, usually at the end of the table, whereas carriers onto which no bit at all may be modulated are usually grouped at the beginning of the table. This calculation is performed according to a fixed algorithm both in the transmitter and the receiver, and the resulting reordered tone ordering tables are also stored both at the transmitter and at the receiver and used for the actual communication. For the ADSL2-Standard, the above procedure is described in detail in Recommendation G.992.3 of the International Telecommunication Union (ITU-T G.992.3), the whole content of which is incorporated by reference herein, in particular in chapter 8.6. Therefore, both the original tone ordering table and the reordered tone ordering table are stored in both the transmitter and the receiver, which requires a considerable amount of memory. It should be noted that the original table is stored because in most of the standards like the ADSL2-Standard referred to above, the original tone ordering table is used during so-called online reconfiguration, i.e. changes in the ordering of the tones or carriers due to changed channel characteristics. The reordering of the carriers in this case is communicated with reference to this table and not with reference to the reordered table. While, in principle, it would be possible to reconstruct the original table from the reordered table, such a procedure is complex and would cost an amount of memory similar to the one needed for storing both tables.

In order to reduce the memory needed, attempts were made to use a purely algorithmic, i.e. deterministic, reordering process for reordering the tone ordering table during reconfiguration. In this case, only one of the tables has to be stored. On the other hand, adaptive reordering of carriers depending on changing transmission characteristics of the communication channel used is not possible.

It is therefore an object of the present invention to provide a method for initializing a data transfer between a first communication device like a transmitter and a second communication device like a receiver, wherein the memory needed for storing tone ordering tables is reduced.

It is a further object of the present invention to provide a method and an apparatus for adapting a data transfer between a first communication device and a second communication device to change noise scenarios of a channel used for transmission, wherein the changes needed are determined at a preferred one of the first and second communication device and easily communicated to the other one of the first and second communication device.

According to a first aspect of the invention, a method and a correspondingly adapted communication device for initializing a data transfer between a first communication device, preferably a transmitter, and a second communication device, preferably a receiver, is provided, in which data transfer data is to be encoded and modulated onto a plurality of carriers, wherein, at the second communication device, a first sequence of said carriers according to which said data is modulated onto said plurality of carriers is calculated, wherein, at the second communication device, a second sequence according to which said data is modulated onto said plurality of carriers is calculated based on said first sequence and based on an encoding technique used for encoding said data, and wherein only said second sequence of said first sequence and said second sequence is transmitted to said first communication device.

Therefore, in said first communication device, only said second sequence which is actually used for communication afterwards is stored, meaning that less memory is used in said first communication device. The first and second sequence may be present in the form of tables, corresponding to the tone ordering tables mentioned in the introductory portion.

Preferably, said first communication device is a transmitter and said second communication device is a receiver with respect to the data transfer to be initialized, since, as explained in the introductory portion, a receiver is better suited for determining a sequence according to which data is modulated onto a plurality of carriers since the receiver is able to analyze noise of the channel, e.g. based on a test sequence received. In this respect, it should be noted that the designations “transmitter” and “receiver” as used herein only relate to the role the respective communication device plays in the data transfer to initialize. As a matter of course, both the first communication device and the second communication device may be transceivers combining functionalities of both transmitter and receiver.

Additionally to said first sequence and said second sequence, a data unit loading table may be determined, said data unit loading tables indicating how many data units, e.g. bits, are to be modulated onto each of the carriers. As a matter of course, this information may be present in a form other than a table as well. In this case, the data unit loading table is also transmitted to said first communication device. In a similar manner, a gain table may be calculated and transmitted, said gain table indicating the gain or power level to be used for each of said carriers in said second sequence.

In a variant of the said first aspect of the invention, it is determined whether said data is to be encoded. If said data is not to be encoded, said first sequence is transmitted to said first communication device and said second sequence is not calculated, whereas in case encoding is used, the method is carried out as described above. Implementing this variant leads to flexible communication devices which may be used both for unencoded and encoded transmission.

According to a second aspect of the present invention, a method and a corresponding apparatus for adapting a data transfer between a first communication device and a second communication device is provided, wherein data is modulated onto a plurality of carriers and wherein at both the first communication device and the second communication device information according to which said data is modulated onto said plurality of carriers is stored, said method comprising the steps of determining a change of said information at said second communication device and transmitting only said change of said information to said first communication device. Again, in this case, preferably the second communication device is a receiver and the first communication device is a transmitter, and the receiver determines said changes based on changes of the noise or attenuation behavior of a channel used for transmitting said data. Said information may in particular comprise a sequence of said carriers, e.g. the second sequence of the first aspect of the invention. In case the sequence is to be changed, said change may involve the change of a position of one of said plurality of carriers within said sequence, and in this case only the old position and the new position is transmitted to said first communication device. Said information may also comprise a gain table indicating a power level to be used for each of said channels. In this case, said change may involve reducing the power level or gain of one of said channels and increasing a power level or gain of another one of said channels by the same amount. In this case, an indicator of said first channel, e.g. in its position within said sequence, an indicator of said second channel and the gain to be donated from said first channel to said second channel is transmitted. Similar to the change of gain, said information may comprise a data unit loading table indicating how many data units, e.g. bits, are to be loaded onto each of said carriers. In this case, said change may involve transferring a number of data units from one of said carriers to another one of said carriers, and an indicator of one of said carriers, an indicator of said another one of said carriers and a number of data units to be donated from said one of said carriers to said another one of said carriers is transmitted to said communication device.

The above-mentioned changes involve two carriers at most. In case more than two carriers are involved, more of the above-explained possibilities may be used in sequence for transmitting the respective changes to said first communication device.

In the following, preferred embodiments of the present invention which are to be taken as examples only are described with reference to the accompanying drawings, wherein

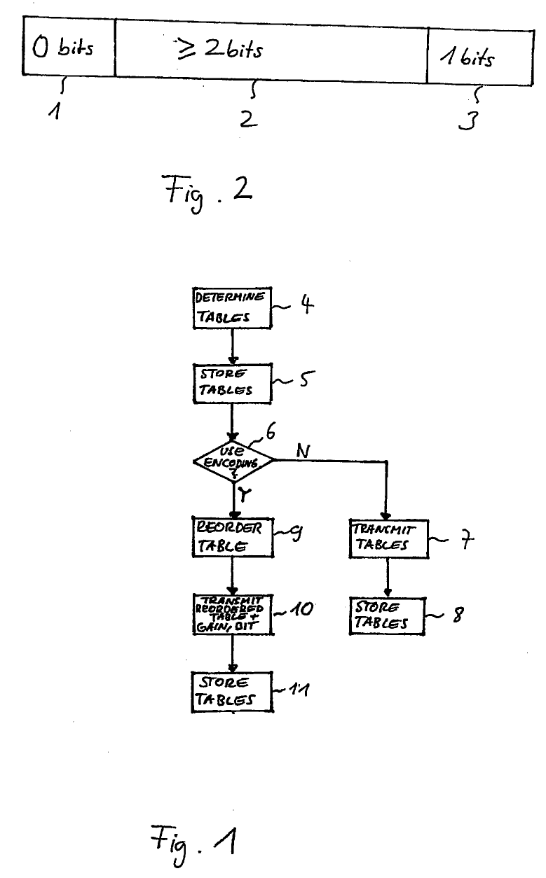

FIG. 1 shows a flow chart of an embodiment of a method according to the present invention,

FIG. 2 schematically shows a reordered tone ordering table,

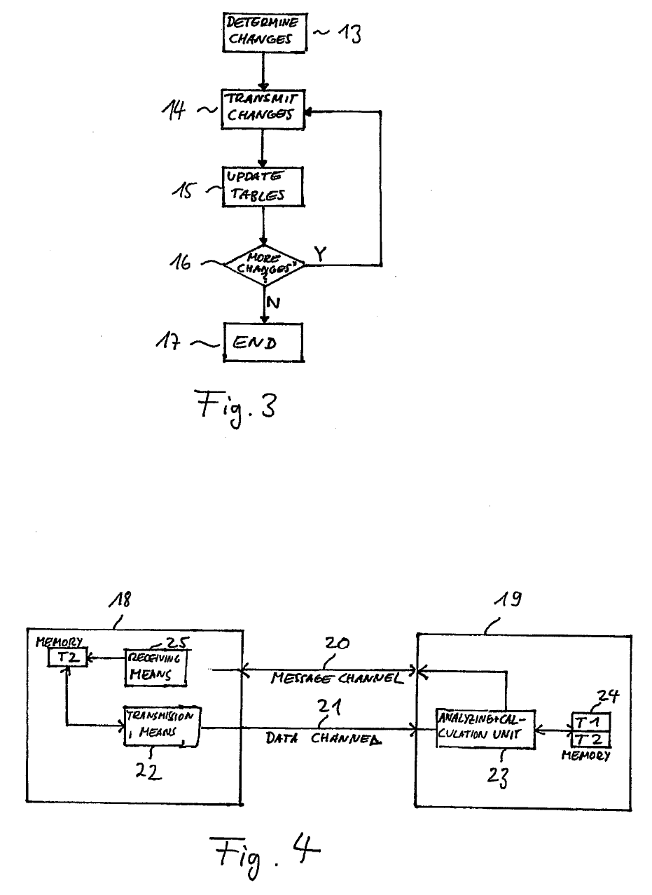

FIG. 3 shows a flow chart of another embodiment of a method according to the present invention, and

FIG. 4 shows an embodiment of a communication system adapted to carry out the method of the present invention.

In FIG. 1, a flow chart of an embodiment of a method for initializing a data transfer between a transmitter and a receiver is shown. The data transfer may in particular be an ADSL data transfer within the framework already explained in the introductory portion, i.e. basically as laid down in ITU-T G992.3 already cited. That is, the data is to be transferred using discrete multi tone modulation with a plurality of carriers or tones, wherein said data may be Trellis coded to lower a bit error rate.

In step 4, the receiver determines a gain scaling, a bit allocation and a tone ordering table for the data transfer. Gain scaling here relates to a power level to be used for each carrier, wherein the overall transmit power is to be kept constant, whereas the allocation of the transmit power to the plurality of channels may be varied. The bit allocation determines how many bits of data are to be modulated onto each channel, said number of bits may be as low as zero for very noisy carriers. The gain scaling and the bit allocation may be stored in tables ordered with increasing frequencies of the carriers used or with any other predetermined order. The tone ordering table indicates in which sequence the carriers should be loaded with bits the simplest, although often non-ideal and consequently rarely employed possibility being to load the carriers according to their frequency. The determination of the gain scaling, the bit allocation and the tone ordering table may be performed by sending a tone test sequence from said transmitter to said receiver, said receiver receiving said test sequence over the channel also used for data transfer later and thus being able to determine noise characteristics of each carrier. Since the determination of gain scaling, bit allocation and the tone ordering table is well known in the art and also laid down in the above ITU-T Recommendation and the present invention is not directed to the determination of these tables in itself but rather to an efficient and memory saving communication of these tables between a receiver and a transmitter, said determination is not described in detail here.

In step 5, the tables are stored in a memory in the receiver.

In step 6, it is checked whether Trellis coding is to be used or not.

If not, in step 7, the tone ordering table as well as the gain scaling table and the bit allocation table is communicated to the transmitter and, in step 8, are stored in a memory in the transmitter for use during data transfer.

If Trellis coding is to be used, in step 9, a reordered tone ordering table is calculated based on the tone ordering table calculated in step 4. Such a reordered tone ordering table is schematically shown in FIG. 2. In section 1, those carriers onto which only zero bits (due to high noise) may be modulated are arranged first, followed by, in section 2, those carriers onto which two or more bits may be modulated. At the end of the table, in a section 3, those carriers onto which a single bit may be modulated are listed. As laid down in detail in the already cited ITU-T Recommendation, this ordering of the carriers is particularly suited for Trellis encoding. Within the sections 1, 2 and 3, the sequence of the carriers is the same as in the tone ordering table calculated in step 4.

In step 10, the reordered tone ordering table together with the gain scaling and the bit allocation is transmitted to the transmitter and, in step 11, stored for use in the data transfer.

In summary, according to the embodiment of the invention shown in FIG. 1, only one tone ordering table, i.e. the reordered table, is transmitted to and stored at the transmitter, consequently saving memory compared to the system as described in the introductory portion. In particular, the tone ordering table communicated to the transmitter is the one actually used for the data transfer afterwards, i.e. the tone ordering table calculated in step 4 if no Trellis coding is used or the reordered tone ordering table calculated in step 9 if Trellis coding is used.

As a matter of course, if Trellis coding is to be used in general, steps 6, 7 and 8 may be omitted.

During data transfer, changes regarding the parameters determined in step 4 of FIG. 1 may become necessary, since noise conditions for specific carriers may change with time. Such a change of the initially determined configuration for data transfer is called online reconfiguration (OLR). A flow chart of an embodiment of a method for communicating respective changes between a transmitter and a receiver is shown in FIG. 3.

This method is in particular suitable for use in combination with the method shown in FIG. 1.

In a first step 13, at the receiver the desired changes regarding the tone ordering, the gain scaling and/or the bit allocation are determined. To achieve this, a process similar to the process of step 4 of FIG. 1 is used the results being compared to the present configuration to determine the changes. This process per se is well known in the art and therefore not described in detail here, the present invention being directed at the communication of the changes between the transmitter and the receiver.

In step 14, the changes determined in step 13 are communicated from the receiver to the transmitter. The format of this communication will be discussed in greater detail below. In general, the changes are communicated relevant to a tone ordering table actually used, in case of only the reordered tone ordering table being communicated to the transmitter (branch Y in FIG. 1), the changes are given relative to this table.

In step 15, the information, i.e. the tone ordering table, the gain scaling table and the bit allocation table at the transmitter and at the receiver are updated according to the changes carried out.

In step 16, it is determined whether further changes have to be transmitted, which may be the case if multiple changes are determined in step 13. If yes, steps 14 and 15 are repeated with the further changes, if no, the method is terminated in step 17.

Next, step 14 of FIG. 3 shall be described in greater detail. In general, as it is also the case in the ITU-T G992.3 Recommendation, the OLR may be divided into two types. Type 1 does not change the net data rate of the data transfer, but reallocates the bits or gains between the carriers. In type 2 OLR, the net data rate is changed by allocating more or less bits and/or more or less gain without balancing from other carriers, this type also being designated as seamless rate adaptation. To indicate that an OLR is to be performed, the receiver first sends a corresponding message to the transmitter. This message is preferably in the known High Level Data Link Control format (HDLC), wherein the type of OLR (type 1 or type 2) is indicated in a header of the HDLC message used. Furthermore, this HDLC message comprises an index named class index which, in a preferred embodiment, is 2 bits long and designates the following classes:
Class 0: Change of bit allocation table, no change of gain scaling table or tone ordering table
Class 1: Change of gain scaling table only
Class 2: Change of bit allocation table and tone ordering table, no change of gain scaling table
Class 3: Change of gain scaling table, bit allocation table and tone ordering table

For efficient communication, for type 1 OLR the receiver, in step 14 of FIG. 3, communicates the following parameters to the receiver, depending on the class of OLR:
Class 0: Index of carrier or tone tₓ that donates Δb bits to carrier or tone t_{y}: (tₓ, Δb, t_{y})
The index of the respective tone is e.g. the position of the carrier within the tone ordering table.
Class 1: Index of carrier tₓ that donates Δg gain to carrier t_{y}: (tₓ, Δg, t_{y})
Class 2: Index of carrier tₓ that donates Δb bits to carrier t_{y}: new position of carrier tₓ and carrier t_{y} within the tone ordering table: (tₓ, Δb, t_{y}) : (tₓ′, t_{y}′), wherein tₓ′ and t_{y}′ are the new positions of carriers tₓ and t_{y}, respectively
Class 3: Index of carrier tₓ that donates Δb bits and Δg gain to carrier t_{y}, new positions tₓ′, t_{y} ′ of tone tₓ and tone t_{y}, respectively

It should be noted since for type 1 OLR the data rate remains constant, an increase of gain or an increase of bits for one carrier always means a corresponding reduction of gains and bits, respectively, for another carrier, in order to keep both the bit rate and the overall transmit power constant.

For changes of more than one pair of carriers, as shown in step 16 of FIG. 3, the messages or parameters as described above will append one after the other, preferably within a single HDLC frame. Since changes of more than one carrier pair are typical for type 2 OLR, the indication of the type in the HDLC header is also an indication for the transmitter whether to expect one of the sets of parameters as described or a plurality of said parameters one after the other. Furthermore, for type 2 OLR, further sets of parameters or classes may be possible similar to class 0 and class 1 above, wherein no carrier t_{y} is given, indicated that the total number of bits or the total gain is changed by changing the bits and/or the gain of carrier tₓ accordingly.

In FIG. 4, a communication system comprising a transmitter 18 and a receiver 19 for carrying out the methods of the present invention as described with reference to FIGS. 1 and 3 is schematically shown. In FIG. 4, only those blocks which are crucial for carrying out the invention are shown. As a matter of course, both the transmitter 18 and the receiver 19 comprise numerous further devices like amplifiers, modulators, demodulators, encoders, decoders etc. which are well known in the art.

The transmitter 18 comprises transmission means 22 for encoding, modulating and transmitting data over a data channel 21 comprising said plurality of carriers to receiver 19. Receiver 19 comprises an analyzing and calculation unit for performing the steps 4, 5, 7, 9, 10, 13 and 14 of FIGS. 1 and 3, i.e. analyzing the noise behavior of the respective carriers, calculating tone ordering table, bit allocation table and gain scaling table as well as the reordered tone ordering table and, during OLR procedures, changes thereof, and transmitting those tables explained with reference to FIG. 1 as well as the changes via a message channel 20 to transmitter 18. As a matter of course, message channel 20 and data channel 21 may be realized within the same physical line, e.g. a copper line.

Receiver 19 further comprises a memory 24 for storing the tone ordering table, designated T1, and the reordered tone ordering table, designated T2. Transmitter 18 comprises receiving means 25 for receiving the messages over message channel 20 from the receiver 19. Furthermore, receiving means 25 evaluates the messages and stores the respective received tone ordering table during initialization, in this case the reordered tone ordering table T2, in a memory 26 and performs the necessary changes on reordered tone ordering table T2 when OLR messages as described with reference to FIG. 3 arrive via message channel 20. As can be seen, only memory for one tone ordering table is needed in transmitter 18. Furthermore, the respective bit allocation tables and gain scaling tables are stored both in memory 24 in the receiver and in memory 26 in the transmitter.

During normal operation, transmitting means 22 uses the information stored in memory 26 for encoding and modulating data to be sent, whereas receiving and analyzing means 23 uses the information in memory 24 for decoding and demodulating the received data.

It should be noted that, in order to realize the present invention, it is not necessary to provide means 22, 23 and 25 which are dedicated solely for carrying the invention but transmitting and receiving means already present for normal data transfer may be used. In particular, if both transmitter 18 and receiver 19 are actually transceivers, transmitting means and receiving means are present in both units. The analyzing functions of receiving and analyzing means 23 may be realized in a digital signal processor or any computing unit present in receiver 19, e.g. for decoding the received data.

Of course, the above-described embodiments of the present invention are to be taken as examples only and are not intended to limit the scope of the present invention. Numerous modifications are possible. For example, while it is generally advantageous to calculate both the initial tone ordering tables as well as the changes in the receiver, the memory saving effect of the method described with reference to FIG. 1 is also conserved if all the calculations are done in the transmitter. Furthermore, while Trellis encoding has been used as an example, a reordered tone ordering table may be calculated to accommodate requirements for other types of coding used. Finally, although the invention has been described with reference to DMT modulations as used with ADSL, it may be applied to any multi-carrier modulation technique and to other communication standards (e.g. VDSL) using such techniques. Therefore, the present invention is only limited by the following claims.

1. A method for initializing a data transfer between a first communication device and a second communication device, in which data transfer data is to be encoded and modulated onto a plurality of carriers, said method comprising the steps of:
determining, at said second communication device, a first sequence of said carriers,
calculating, at said second communication device, a second sequence of said carriers based on said first sequence and on an encoding technique used for said encoding of said data, and
transmitting only said second sequence of said first sequence and said second sequence to said first communication device.

2. The method according to claim 1, wherein said data transfer is a transfer of data from said first communication device to said second communication device.

3. The method according to claim 1, wherein said step of determining said first sequence is carried out based on transmission characteristics of said carriers.

4. The method according to claim 1, wherein said encoding technique is a Trellis-type coding.

5. The method according to claim 1, further comprising the step of:
determining, at said second communication device, for each of said carriers, a number of data units of said data to be modulated onto the respective carrier.

6. The method according to claim 5, further comprising the step of:
transmitting said number of data units for each of said carriers to said first communication device.

7. The method according to claim 5, wherein said step of calculating said second sequence comprises reordering said first sequence such that carriers onto which a single data unit is to be modulated are arranged at the end of said second sequence.

8. The method according to claim 5, wherein said step of calculating said second sequence further comprises reordering said first sequence such that carriers onto which no data units are to be modulated are arranged at the beginning of said second sequence.

9. The method according to claim 5,
wherein said data units are bits.

10. The method according to claim 1, wherein said method further comprises the steps of:
calculating, at said second communication device, a gain for each of said carriers, and
transmitting said gains calculated for each of said carriers to said first communication device.

11.-20. (canceled)

21. A method for initializing a data transfer between a first communication device and a second communication device, in which data transfer data is to be modulated onto a plurality of carriers, said method comprising the steps of:
determining, at said second communication device, a first sequence of said carriers,
determining, at said second communication device, whether said data is to be encoded,
if said data is not to be encoded,
transmitting said first sequence to said first communication device, and
if said data is to be encoded,
calculating, at said second communication device, a second sequence of said carriers based on said first sequence and on an encoding technique used for said encoding of said data, and
transmitting only said second sequence of said first sequence and said second sequence to said first communication device.

22. A method for adapting a data transfer between a first communication device and a second communication device, wherein for said data transfer data is modulated onto a plurality of carriers, and wherein, both at the first communication device and at the second communication device, information regarding modulation of said data onto said plurality of carriers is stored, said method comprising the steps of:
determining, at said second communication device, changes of said information,
modifying said information stored at said second communication device according to said changes,
transmitting parameters indicative of said changes from said second communication device to said first communication device, and
modifying said information stored at said first communication device according to said changes based on said parameters.

23. The method according to claim 22,
wherein said information comprises a sequence of said carriers according to which said data is modulated onto said carriers, and
wherein said changes comprise at least one change of position of one of said carriers within said sequence.

24. The method according to claim 23,
wherein said sequence is determined during initialization of the data transfer,
wherein said initialization comprises the steps of:
determining, at said second communication device, a first sequence of said carriers,
calculating, at said second communication device, a second sequence of said carriers based on said first sequence and on an encoding technique used for said encoding of said data,
transmitting only said second sequence of said first sequence and said second sequence to said first communication device, and
using said second sequence as said sequence comprised in said information.

25. The method according to claim 22,
wherein said information comprises, for each of said carriers, a number of data units to be modulated onto each of said carriers, and
wherein said changes comprise changing a number of data units to be modulated onto at least one of said carriers.

26. The method according to claim 25,
wherein said changing of the number of data units comprises transferring a number of data units from one of said carriers to another one of said carriers.

27. The method according to claim 22,
wherein said information comprises respective gains for each of said carriers, and
wherein said changes comprise changing at least one of said respective gains.

28. The method according to claim 27,
wherein said changing of said at least one gain comprises increasing one of said respective gains and decreasing another one of said respective gains by the same amount.

29. The method according to claim 22,
wherein said changes are divided into two types, a first type involving no change of an overall data rate of the data transfer and the second type involving a change of the overall data rate of the data transfer, and
wherein said step of transmitting said parameters indicative of said changes to said first communication device comprises communicating said type of said changes to said first communication device.

30. The method of claim 22,
wherein said step of transmitting said parameters indicative of said changes to said first communication device comprises sending an HDLC message comprising said parameters to said first communication device.

31.-39. (canceled)

40. A communication system operable to initialize a data transfer between a first communication device and a second communication device, wherein data transfer data is to be encoded and modulated onto a plurality of carriers, said communication system comprising:
a. a transmitter; and
b. a receiver operable to (i) determine a first sequence of said carriers, (ii) calculate a second sequence of said carriers based on said first sequence and on an encoding technique used for said encoding of said data, and (iii) transmit only said second sequence of said first sequence and said second sequence to said transmitter.

41. The system of claim 40 wherein said receiver is operable to receive said data during said data transfer.

42. The system according to claim 40 wherein said receiver is operable to determine said first sequence based on transmission characteristics of said carriers.

43. The system of claim 40 wherein said encoding technique is a Trellis-type coding.

44. The system of claim 40 wherein said receiver is further operable to determine, for each of said carriers, a number of data units of said data to be modulated onto the respective carrier.

45. The system of claim 44 wherein said receiver is further operable to transmit said number of data units for each of said carriers to said transmitter.

46. The system of claim 44 wherein calculation of said second sequence by said receiver comprises reordering said first sequence such that carriers onto which a single data unit is to be modulated are arranged at the end of said second sequence.

47. The system of claim 44wherein calculation of said second sequence by said receiver comprises reordering said first sequence such that carriers onto which no data units are to be modulated are arranged at the beginning of said second sequence.

48. The system of claim 44 wherein said data units are bits.

49. The system of claim 40 wherein said receiver is further operable to calculate a gain for each of said carriers, and transmit said gains calculated for each of said carriers to said transmitter.

50. A communication system comprising:
a first communication device operable to transfer data to a second communication device,
wherein for a data transfer between said first communication device and said second communication device data is modulated onto a plurality of carriers, wherein, both the first communication device and the second communication device comprise memory means for storing information regarding modulation of said data onto said plurality of carriers,
said second communication device operable to
(i) determine, at said second communication device, changes of said information,
(ii) modify said information stored at said second communication device according to said changes, and
(iii) transmit parameters indicative of said changes from said second communication device to said first communication device, and
said first communication device operable to modify said information stored at said first communication device according to said changes based on said parameters.

51. The system according to claim 50 wherein said information comprises a sequence of said carriers according to which said data is modulated onto said carriers, and wherein said changes comprise at least one change of position of one of said carriers within said sequence.

52. The system according to claim 51 wherein said sequence is determined during an initialization of the data transfer, and wherein said second communication device is operable to, during initialization of the data transfer,
(i) determine a first sequence of said carriers,
(ii) calculate a second sequence of said carriers based on said first sequence and on an encoding technique used for said encoding of said data, and
(iii) transmit only said second sequence of said first sequence and said second sequence to said first communication device.

53. The system according to claim 50 wherein said information comprises, for each of said carriers, a number of data units to be modulated onto each of said carriers, and wherein said changes comprise changing a number of data units to be modulated onto at least one of said carriers.

54. The system according to claim 53 wherein said changing of the number of data units comprises transferring a number of data units from one of said carriers to another one of said carriers.

55. The system according to claim 50 wherein said information comprises respective gains for each of said carriers, and wherein said changes comprise changing at least one of said respective gains.

56. The system according to claim 55 wherein said changing of said at least one gain comprises increasing one of said respective gains and decreasing another one of said respective gains by the same amount.

57. The system according to claim 50
wherein said changes are divided into two types, a first type involving no change of the overall data rate and the second type involving a change of the overall data rate of the data transfer, and
wherein transmission of said parameters indicative of said changes to said first communication device comprises communicating said type of said changes to said first communication device.

58. The system according to claim 50 wherein transmission of said parameters indicative of said changes to said first communication device comprises sending an HDLC message comprising said parameters to said first communication device.
